(19) United States
(12) Patent Application Publication
(10) Pub. No.: US 2008/0299328 A1
(43) Pub. Date: Dec. 4, 2008

(54) Liquid crystal display fabrication and device

(76) Inventor: Po-Wen Hsu, Tainan (TW)

Correspondence Address: TROP PRUNER & HU, PC, 1616 S. VOSS ROAD, SUITE 750, HOUSTON, TX, 77057-2631, US

(21) Appl. No.: 11/809,309

(22) Filed: May 31, 2007

(51) Int. Cl. C09K 19/00; B05D 3/10

(52) U.S. Cl. 428/1.1; 427/307; 428/167

(57) ABSTRACT

A liquid crystal display panel may have a substrate body, a patterned overcoat layer disposed on the substrate body, and a transparent conductive layer disposed on the patterned overcoat layer. The patterned overcoat layer may have a plurality of slits, the depth of the slits greater than the thickness of the transparent conductive layer. By using the height difference of the slits in the overcoat layer and the thickness of the transparent conductive layer, the transparent conductive layer may be patterned during formation. Thus, the fabricating process can be simplified, the cost reduced, and the through put and the productive yield improved.

### TECHNICAL FIELD

The present invention relates generally to liquid crystal displays and methods for fabricating the same.

### BACKGROUND

Liquid crystal displays (LCD) have become a mainstream product in the market. This may be due, at least in part, to increased environmental concerns. This may also be due to the high picture quality, high degree of spatial utilization, low power consumption, and radiation-free operation of LCDs. LCDs may also include high contrast ratio, no gray scale inversion, little color shift, high luminance, high color content, high color saturation level, rapid response, and wide viewing angle.

Current techniques capable of meeting the demand for a wide viewing angle include a twisted nematic (TN) liquid crystal display with an added wide viewing film, an in-plane switching (IPS) liquid crystal display, a fringe field switching liquid crystal display, and a multi-domain vertical alignment (MVA) liquid crystal display. With respect to the MVA liquid crystal display, alignment protrusions or slits can be formed on a thin-film transistor (TFT) array plate and/or another substrate to activate the liquid crystal molecules sandwiched between the TFT plate and substrate, for alignment in multiple directions.

Referring to FIGS. 1A and 1B, a conventional color filtering plate 100 includes a substrate 110, a light-shielding matrix 122 disposed on the substrate 110, a plurality of color filtering films 124 on the light-shielding matrix 122, an overcoat layer 130 disposed over the light-shielding matrix 122 and the color filtering films 124, and a patterned pixel electrode 140 with multiple slits 142 disposed on the overcoat layer 130.

Conventionally, a mask process is used to form the slits 142 in pixel electrode 140. For example, a mask may be formed on the electrode layer 140 to protect areas from being etched during slit 142 formation. However, the mask process is time consuming and costly, and it may limit productive yield. Moreover, as liquid crystal display panels increase in size a larger mask is needed or the frequency of exposure using the original sized mask increases. The larger mask takes more productive cost, and the increased exposure times extend the processing time and decrease productive yield and through put. Thus, a simplified, low-cost method for fabricating an LCD is needed.

### BRIEF DESCRIPTION OF THE DRAWINGS

FIG. 1A is a top view of a conventional color filtering plate of a liquid crystal display.

FIG. 1B is a cross-section of the conventional color filtering plate of FIG. 1A taken generally along line A-A′.

FIGS. 2A, 3A, and 4A are top views illustrating the fabrication of a substrate of a liquid crystal display panel according to an embodiment.

FIGS. 2B, 3B, and 4B are cross-sections taken generally along line B-B′ of FIGS. 2A, 3A, and 4A respectively.

FIGS. 5A, 6A, 7A, 8A, and 9A are top views illustrating the fabrication of a substrate of a liquid crystal display panel according to an embodiment.

FIGS. 5B, 6B, 7B, 8B, and 9B are cross-sections taken generally along line C-C′ of FIGS. 5A, 6A, 7A, 8A, and 9A respectively.

FIG. 10 is a cross-section illustrating a liquid crystal display panel according to an embodiment.

FIG. 11 illustrates a cross-section of a liquid crystal display according to an embodiment.

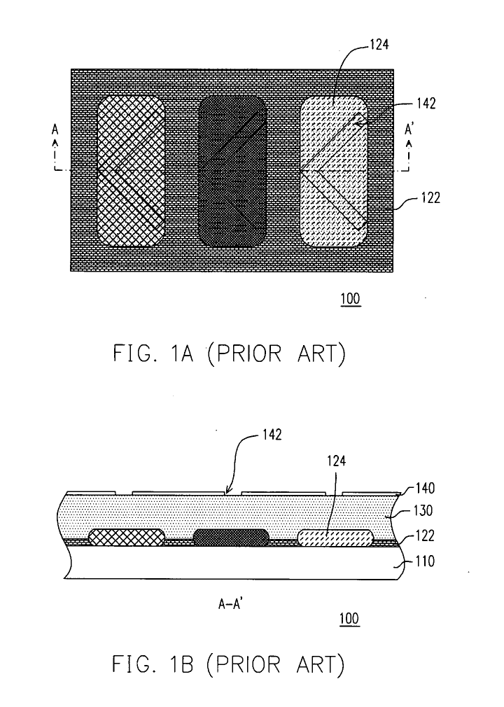

### DETAILED DESCRIPTION

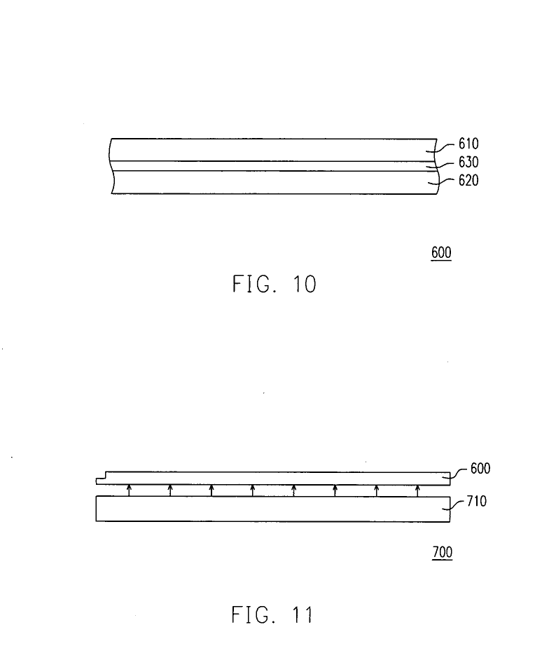

A liquid crystal display panel 600 (FIG. 10) may include a first substrate 610, a second substrate 620, and a liquid crystal layer 630. Typically, the second substrate 620 is opposite the first substrate 610, and the liquid crystal layer 630 is sandwiched between the substrates 610 and 620. The first substrate 610 can be a color filter on array (COA) substrate or a thin film transistor (TFT) array substrate, although embodiments are not limited to these examples. Furthermore, the first substrate 610 may include alignment structures such as alignment protrusions or slits. Generally, alignment structures cause the liquid crystal molecules in the liquid crystal layer 630 to align in multiple directions when an electric field is applied between the substrates 610 and 620. If the first substrate 610 is a COA or TFT substrate, the second substrate 620 can be a transparent substrate or a color filter substrate, respectively. Embodiments however are not so limited: the second substrate may be another type of substrate such as a COA substrate. According to some embodiments, a substrate of the liquid crystal display panel 600, such as substrate 620, may be fabricated using simplified methods that provide high conductive yield, increased throughput, and decreased cost.

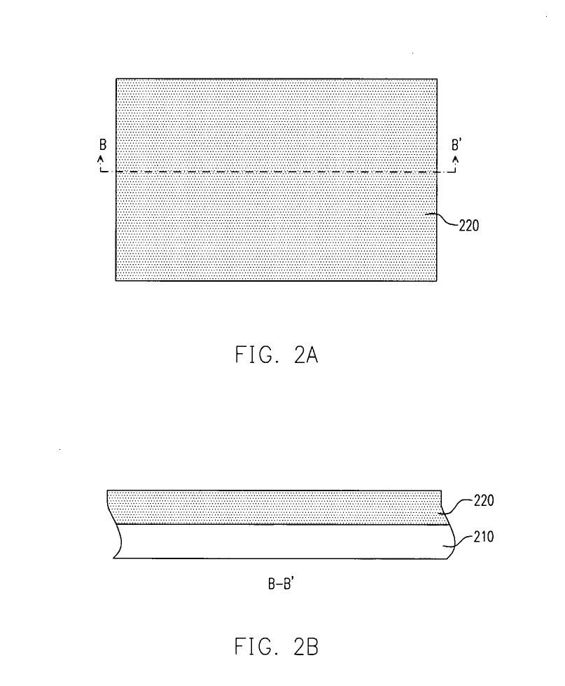

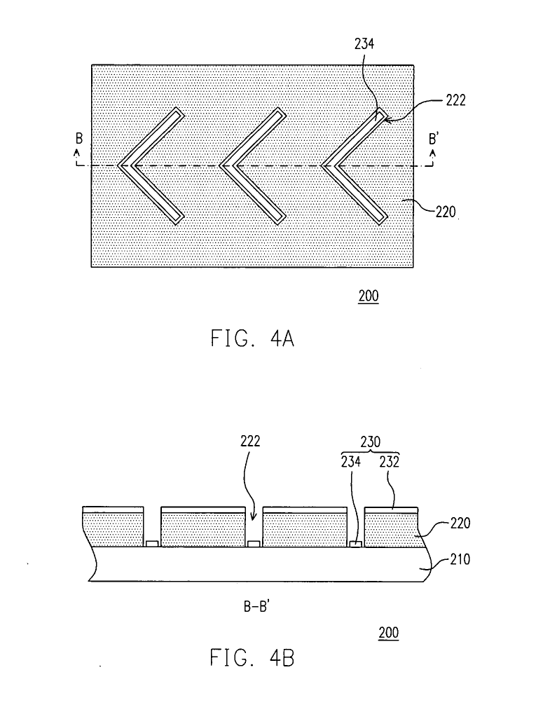

For example, a second substrate 200, which is depicted in FIGS. 4A and 4B, may be fabricated using simplified methods. To fabricate the substrate 200, a substrate body 210 is provided, which is shown in FIG. 2B. The substrate body 210 may be a transparent material such as glass, quartz, or another transparent material. Thereafter, an overcoat layer 220 may be formed on the substrate body 210, as is shown in FIGS. 2A and 2B. In some embodiments, the overcoat layer 220 is formed by known techniques, but overcoat layer 220 formation is not limited thereto. The formed overcoat layer 220 may be transparent and nonconductive, and it may or may not be photosensitive. Silicon oxide (SiO₂) is one example of a suitable overcoat material that is not photosensitive. As is shown in FIG. 2B, the overcoat layer 220 has a thickness.

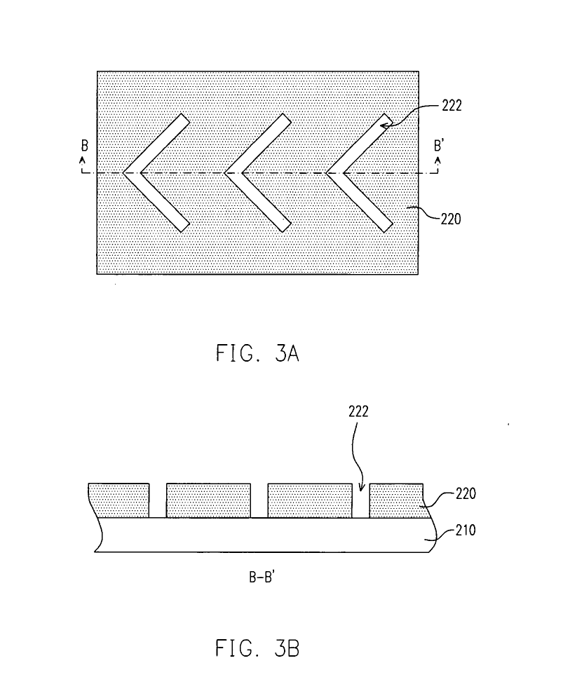

Referring to FIGS. 3A and 3B, the overcoat layer 220 may be patterned to form a plurality of slits 222. In some embodiments the overcoat layer 220 may be patterned to form slits 222 with a V-shaped pattern. Embodiments are not limited to V-shaped slits 222: the slits 222 may have any other suitable shape or pattern. If the overcoat layer 220 is photosensitive, the slits 222 may be formed by first exposing the photosensitive overcoat layer 220 to light and then developing the exposed overcoat 220. Alternatively, if the overcoat layer 220 is not photosensitive, the slits 222 may be formed by wet etching, laser ablation, or another manufacturing technique. Overdeveloping or over-etching the overcoat layer 220, or the like, may result in slits 222 that have substantially vertical sidewalls. That is, during processing the sidewall of each slit 222 can be undercut with an angle 224 that is less than or equal to 90 degrees. The sidewalls of the slits 222 may define a slit depth that is approximately equal to the thickness of the overcoat layer 220, although embodiments are not so limited. The height of the sidewalls or the depth of the slits 222 however is enough to enable the patterning of a transparent conductive layer (FIGS. 4A and 4B at 230) without using a subsequent mask.

For example, referring to FIGS. 4A and 4B, after the slits 222 are formed in the overcoat layer 220, a conductive material, such as indium tin oxide (ITO), indium zinc oxide (IZO), or the like, is deposited to form a transparent conductive layer 230. The layer 230 may be deposited by physical vapor deposition (PVD) in some embodiments. As is shown in FIGS. 4A and 4B, the transparent conductive layer 230 is not as thick as the slits 222 are deep. Thus, the deposited transparent conductive layer 230 has two patterns, a first pattern 232 and a second pattern 234. Notably, the first pattern 232 and second pattern 234 are isolated or separated from each other. For example, the first pattern 232 is formed on the surface of the overcoat layer 220, and the second pattern 234 is formed in the slits 222. Because the patterns 232 and 234 are isolated, slits may be formed in the transparent conductive layer 230 without using a mask process. The elimination of the mask process simplifies the fabrication of the substrate 200 and the liquid crystal display device. As fabrication processes are simplified, the conductive cost can be reduced, and the throughput and productive field of the process can be improved. Furthermore, process pollution or defects in the overcoat layer can be reduced as part of the overcoat layer 220 is removed for slit 222 formation. Therefore, a superior productive yield is attained.

In some embodiments, the first pattern 232 on the surface of the overcoat layer 220 is a pixel electrode with alignment slits formed thereon. That is, in embodiments where the conductive layer 230 is to be a pixel electrode, the first pattern 232 forms the pixel electrode. The second pattern 234 in the slits 222 enables alignment slits to be formed in the pixel electrode without a mask process. Embodiments are not limited to the formation of a pixel electrode: in other embodiments, the first pattern 232 may be another electrode such as a common electrode layer with alignment slits formed therein, the alignment slits corresponding with the slits 222 in the overcoat.

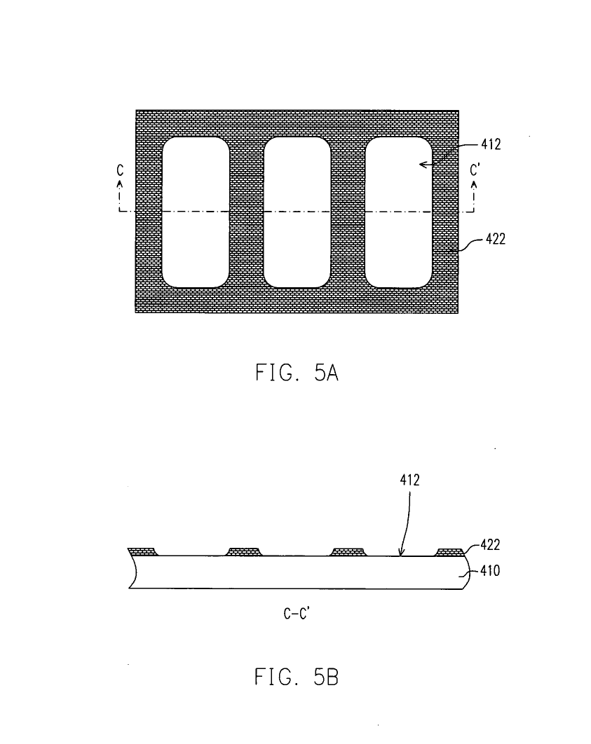

The substrate 200 can be a transparent substrate or a COA substrate. The substrate 620 however can also be a color filter substrate. The processing of a color filter substrate is similar to the processing of substrate 200 with the addition of a color filtering device. For example, referring to FIGS. 5A and 5B, a substrate body 410 is provided. The substrate body 410 may be glass, quartz, or another transparent material. The substrate body 410 of the color filter substrate may have a color filtering device 420 formed thereon. To form the color filtering device 420, a light-shielding matrix 422 is deposited on the substrate body 410. The light-shielding matrix 422 can be for example chromium, a black resin, or another light shielding material. Typically, the light-shielding matrix 422 is patterned to define a plurality of pixel regions 412.

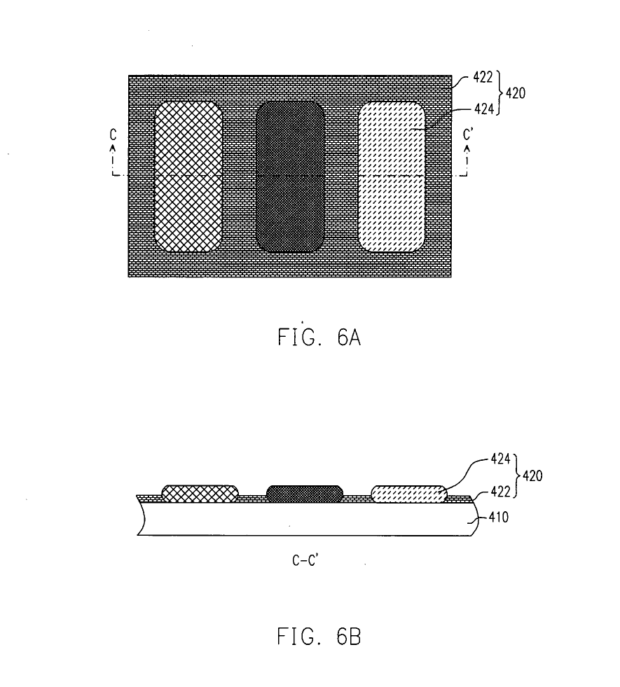

Referring to FIGS. 6A and 6B, the color filter device 420 may also include a plurality of color filters 424 to filter colors such as red, green, and blue. The color filters 424 are formed in corresponding pixel regions 412 by printing, as one example. The color filters 424 can be formed from a color resin or another color dye, although embodiments are not limited thereto.

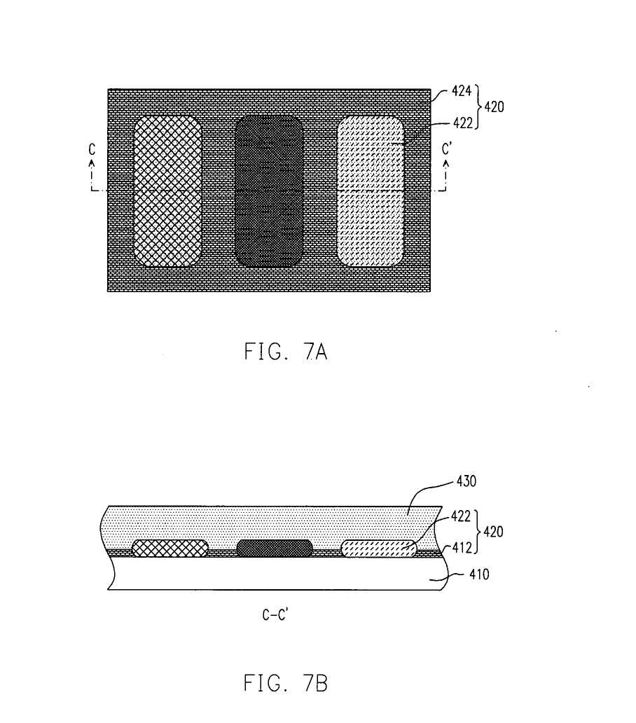

Thereafter, as is shown in FIGS. 7A and 7B, an overcoat layer 430 may be formed over the light-shielding matrix 422 and the color filters 424. Like the overcoat layer 220, the overcoat layer 430 is a transparent, nonconductive material that may or may not be photosensitive, and the overcoat layer 430 has a thickness.

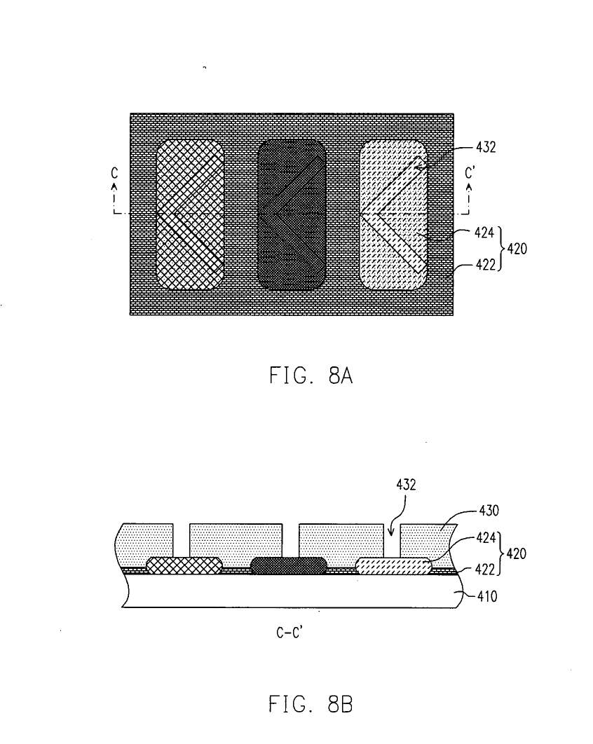

Referring to FIGS. 8A and 8B, the overcoat layer 430 can be patterned to form a plurality of slits 432. The sidewall of each slit may be substantially vertical or an undercut shape due to over-etching or over-development during slit 432 formation. That is, if the overcoat layer 430 is patterned by exposure and development of photosensitive material, or if it is patterned by wet etching, laser ablation, or the like of a non-photosensitive material, the overcoat layer 430 may be over-processed to form slits 432 having substantially vertical or undercut sidewalls. In one embodiment, the height of the sidewalls or the depth of the slits 432 may be less than the thickness of the thickest part of the overcoat layer 230. Furthermore, the slits 432 may be patterned to have a V-shape or any other suitable slit design.

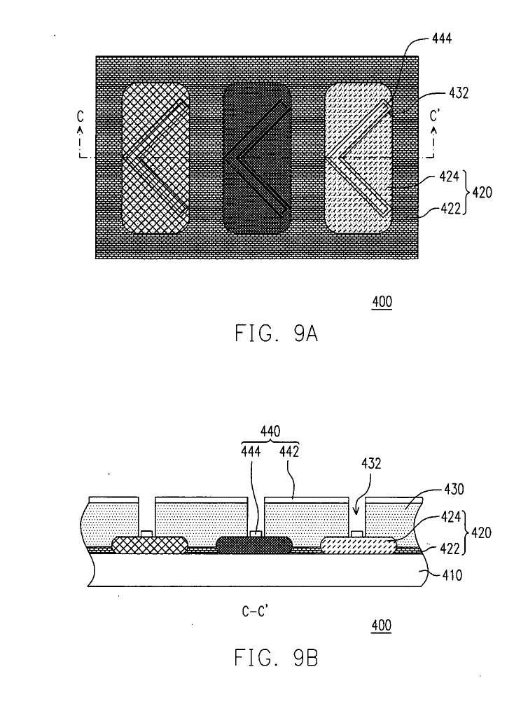

Referring to FIGS. 9A and 9B, a transparent conductive material such as ITO, IZO, or another transparent material is deposited over the substrate body 410, for example by PVD, to form a transparent conductive layer 440. The transparent, conductive layer 440 has a first pattern 442 disposed on the surface of the overcoat layer 430 and a second pattern 444 disposed within the slits 432. The height difference between the slits 432 and the transparent conductive layer 440 enables the transparent conductive layer 440 to be patterned without the use of a subsequent mask process. Thus, in an embodiment a pixel electrode 442 can be deposited that does not need to undergo subsequent mask processing to have alignment slits formed therein.

Referring back to the display panel 600 of FIG. 10, the second substrate 620 can be a substrate such as substrate 200 or 400 in some embodiments. In compliance with the second substrate 620 type, the first substrate 610 may be a COA substrate, a TFT array substrate, or a transparent substrate. Moreover, the first substrate 610 may have alignment structures such as alignment protrusions or slits formed thereon.

Referring to FIG. 11, the liquid crystal display panel 600 may be combined with a backlight unit 710 to form a liquid crystal display 700. In some embodiments, the backlight unit 710 may be disposed adjacent to an active device array plate of the liquid crystal display panel 600. The active device array plate may be either the first substrate 610 or the second substrate 620 depending upon the embodiment. The backlight unit 710 provides light to the liquid crystal display panel 600 to perform a display function. In the present example the backlight unit 710 is a directly-type backlight unit however an edge-type backlight unit can also be adopted.

While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A liquid crystal display panel substrate, comprising:
an overcoat layer disposed on a substrate body, the overcoat layer patterned to form a plurality of slits; and
a transparent conductive layer disposed on the patterned overcoat layer, the transparent conductive layer having a first pattern and a second pattern, the second pattern separated from the first pattern and disposed within the slits.

2. The substrate of claim 1, further comprising a color-filtering device, said overcoat layer disposed over the color-filtering device.

3. The substrate of claim 1, wherein each slit in said plurality has either a substantially vertical sidewall or an undercut sidewall.

4. The substrate of claim 1, wherein the overcoat layer is transparent and non-conductive.

5. The substrate of claim 1, wherein the overcoat layer is photosensitive.

6. The substrate of claim 1, wherein the patterned overcoat layer is silicon oxide.

7. A liquid crystal display device, comprising:
a first substrate;
a second substrate opposite the first substrate, the second substrate including an overcoat layer with a plurality of slits and a transparent conductive layer, the transparent conductive layer including a first pattern and a second pattern, the first pattern formed on the surface of the overcoat layer and the second pattern formed in the slits; and
a liquid crystal layer disposed between the first substrate and the second substrate.

8. The liquid crystal display device of claim 7, wherein said second substrate includes a color-filtering device, the overcoat layer over the color-filtering device.

9. The liquid crystal display device of claim 7, wherein each slit in said plurality has either a substantially vertical sidewall or an undercut sidewall.

10. The liquid crystal display device of claim 7, wherein the slits in said plurality are deeper than the thickness of the transparent conductive layer.

11. The liquid crystal display device of claim 7, wherein the overcoat layer is transparent, non-conductive, and photosensitive.

12. The liquid crystal display device of claim 7, wherein the overcoat layer is silicon oxide.

13. The liquid crystal display device of claim 7, wherein the first substrate is a thin film transistor array plate.

14. The liquid crystal display device of claim 7, further comprising a backlight unit adjacent the first substrate.

15. A method for fabricating a liquid crystal display panel substrate, comprising:
forming a plurality of slits in an overcoat layer that is disposed on a substrate body; and
without using a mask, forming a transparent conductive layer having two isolated patterns on the overcoat layer.

16. The method of claim 15, further comprising forming a color-filtering device on the substrate body, the overcoat layer formed over the color-filtering device.

17. The method of claim 15, wherein forming a plurality of slits includes exposing a photosensitive overcoat layer to light and developing the photosensitive overcoat layer such that the slits in said plurality have substantially vertical sidewalls.

18. The method of claim 15, wherein forming a plurality of silts includes forming said slits by laser ablation.

19. The method of claim 15, wherein forming a transparent conductive layer having two isolated patterns on the overcoat layer includes forming one of the two isolated patterns on the surface of the overcoat layer and forming the other of the two isolated patterns in the slits.

20. The method of claim 15 wherein forming a plurality of slits in an overcoat layer and forming a transparent conductive layer includes forming slits that are deeper than the thickness of the transparent conductive layer to enable the isolation of said two isolated patterns.
